(19) United States
(12) Patent Application Publication
(10) Pub. No.: US 2004/0224217 A1
(43) Pub. Date: Nov. 11, 2004

(54) Integrated membrane electrode assembly using aligned carbon nanotubules

(76) Inventor: Todd Jefferson Toops, Knoxville, TN (US)

Correspondence Address: UT-Battelle, LLC, 111 Union Valley Rd., PO Box 2008, Mail Stop 6498, Oak Ridge, TN, 37831, US

(21) Appl. No.: 10/431,864

(22) Filed: May 8, 2003

(51) Int. Cl. H01M 4/96; H01M 8/10; H01M 4/92; B05D 5/12; H01M 4/88

(52) U.S. Cl. 429/44; 429/38; 429/30; 429/33; 427/115; 502/101

(57) ABSTRACT

The invention is an integrated membrane electrode assembly, method for using the assembly in a proton exchange membrane (PEM) fuel cell, and methods for making the assembly using axially aligned carbon nanotubules. The preferred embodiment of the integrated membrane electrode assembly has at least one proton exchange membrane having a cathode surface and an anode surface, at least one axially aligned carbon nanotubule anode layer disposed on the PEM anode surface, at least one axially aligned carbon nanotubule cathode layer disposed on the PEM cathode surface, and a catalyst disposed along the annulus of the carbon nanotubules of the anode layer and the cathode layer. The assembly transports reaction gases along the aligned axes of the anode and cathode layers in an essentially one-dimensional diffusion pathway for contact with the catalyst thereby improving the mass activity of the assembly.

### STATEMENT REGARDING FEDERAL SPONSORSHIP

This invention was made with Government support under contract no. DE-AC05-00OR22725 to UT-Battelle, LLC, awarded by the United States Department of Energy. The Government has certain rights in the invention.

### BACKGROUND OF THE INVENTION

There is a growing interest in the development of alternative power sources in all areas of energy production. A field that has shown remarkable technological progress over the past thirty years is the fuel cell, particularly the proton-exchange membrane fuel cell (PEMFC). Hurdles still exist in each step of this fuel cell system, but one area that requires particular attention is the high cost of using platinum (Pt) in the active layer of the anode and cathode. The chemical reactions necessary for fuel cells to generate power do not occur at the temperatures of interest (80-120° C.) without a catalyst, and Pt is the most efficient catalyst for both the hydrogen oxidation reaction in the anode and the oxygen reduction reaction in the cathode; there are currently no known cost-effective alternatives to this noble metal. The current target for a competitive PEMFC is $45/kW by 2010 with an additional goal of $30/kW set for 2015. According to an Arthur D. Little study, the current cost of precious metals alone in the present day fuel cell is $65/kW, an estimated one-fifth of the total cost, which illustrates the necessity of marked improvement in this step alone.

Platinum is the best available catalyst for the hydrogen oxidation reaction at the anode, which proceeds according to the following mechanism:

$${H}_{2} + 2 Pt \to 2 H - Pt$$

$$\underline{2 [ H - Pt \to Pt + {H}^{+} + {e}^{-} ]}$$

$${H}_{2} {\to }^{Pt} 2 {H}^{+} + 2 {e}^{-}$$

The electrons flow out of the anode through an external circuit and then to the cathode, while the H⁺ proton permeates or diffuses through the PEM to the cathode. They then react with O₂ according to the following stoichiometry:

$${O}_{2} + 4 {H}^{+} + 4 {e}^{-} {\to }^{Pt} 2 {H}_{2} O$$

While the H₂ oxidation reaction and mechanism is well understood there is still not a well-established mechanism describing the O₂ reduction at the cathode, so only the overall reaction can be accurately displayed. A significant concern in using Pt in the PEMFC is the poisoning effect of trace amounts of CO in the fuel source. Improvements have recently been demonstrated either using Pt alloys or bleeding O₂ into the anode, but further improvements are still necessary. Another key concern in PEMFCs is overpotential, or the loss of power through interactions that do not generate power, such as electrical resistance, reversible reactions, mass-transfer limitations, etc. In general, the number of steps in a process is proportional to the overpotential associated with the process; for instance, the overpotential in the cathode, a 4 e⁻ interaction, is generally an order of magnitude higher than in the anode, a 2 e⁻ interaction. Other contributions to overpotential arise from proton mobility, or diffusion, through the electrodes and PEM, and especially the transition between these phases; in fact, recent studies have shown that the impregnation of the PEM into a small portion of the electrodes lead to a 10-fold improvement in performance because the transfer mobility of reactants was improved.

A study by Joo et al. [S. H. Joo, S. J. Choi, J. Kwak, Z. Liu, O. Terasaki, R. Ryoo, Nature, 412 (2001) 169] suggests that further improvements can be made if the support used to disperse the Pt throughout the electrode is optimized to decrease overpotential. They used small clusters of nanotubes in their electrodes rather than small clusters of carbon black. The resulting electrode assembly displayed an order of magnitude increase in the mass activity per gram of platinum (A/g of Pt) compared to a standard carbon black electrode. The increase in activity is reportedly due to a decrease in Pt cluster size, which exposes more Pt atoms to the gas-phase reactants. This is without question a desirable feature, however their experiments show only a doubling of these surface Pt atoms, which means that a second unidentified factor is involved. A discovery of this invention is this second factor.

### BRIEF SUMMARY OF THE INVENTION

The invention is an integrated membrane electrode assembly, method for using the assembly in a proton exchange membrane (PEM) fuel cell, and methods for making the assembly using axially aligned carbon nanotubules. The preferred embodiment of the integrated membrane electrode assembly has at least one proton exchange membrane having a cathode surface and an anode surface, at least one axially aligned carbon nanotubule anode layer disposed on the PEM anode surface, at least one axially aligned carbon nanotubule cathode layer disposed on the PEM cathode surface, and a catalyst disposed along the annulus of the carbon nanotubules of the anode layer and the cathode layer. The assembly transports reaction gases along the aligned axes of the anode and cathode layers in an essentially one-dimensional diffusion pathway for contact with the catalyst thereby improving the mass activity of the assembly.

### BRIEF DESCRIPTION OF THE DRAWINGS

FIG. 1 is a diagram of the invention assembly showing the major components.

FIGS. 2(a-d) are the primary method steps of making the preferred embodiment of the invention.

FIG. 3 is a schematic of a fuel cell stack and a single cell.

FIG. 4 shows the prior art platinum dispersion on porous carbon black supports FIG. 4(a); and the instant invention showing platinum deposited on a continuous array of carbon nanotubules FIG. 4(b).

### DETAILED DESCRIPTION

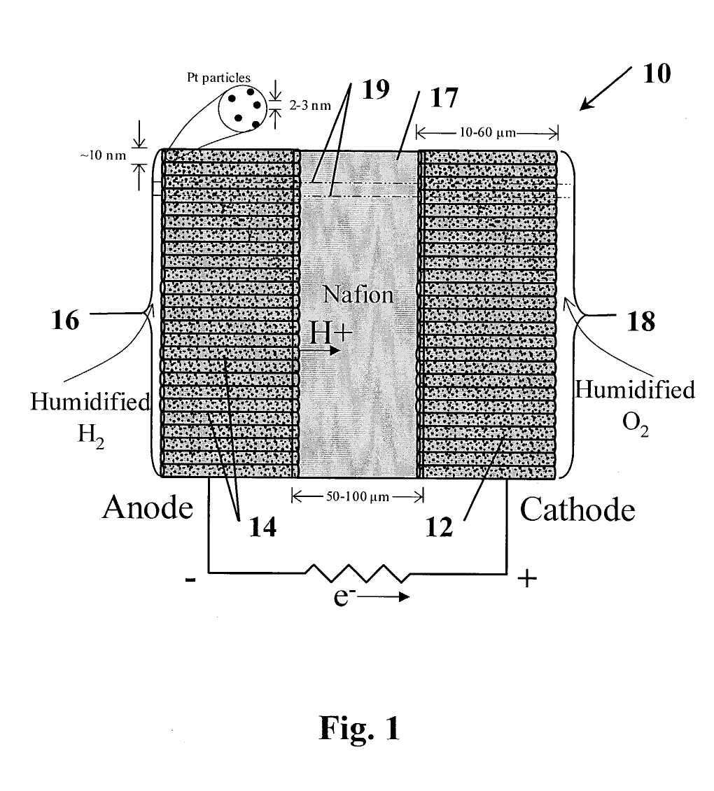

An embodiment of the invention comprises at least one electrode assembly 10 as shown in FIG. 1, using axially aligned carbon nanotubules 12 having approximately 20 nanometer (nm) outside diameter and approximately 10 nm inside diameter, with platinum (Pt) particles 14 deposited on the interior and/or exterior walls, or the annulus, of the nanotubules. An axially aligned carbon nanotubule anode layer 16 of the electrode assembly 10 is infused on the anode surface of the proton exchange membrane (PEM) 17 and an axially aligned carbon nanotubule cathode layer 18 is infused on the cathode surface of the PEM 17. A portion of the anodic nanotubule layer 16 and cathodic nanotubule layer 18 are impregnated with the proton exchange membrane (PEM) 17 and both are axially aligned such that the pathway from the reactant gas-phase to the PEM 17 is minimized. The assembly 10 transports reaction gases along the aligned axes of the anode layer 16 and cathode layer 18 in an essentially one-dimensional diffusion pathway for contact with the catalyst 14 thereby improving the mass activity of the assembly 10. The carbon nanotubule 12 dimensions are in the range of 18 to 22 nm outside diameter, 5 to 15 nanometers inside diameter, and 10 to 60 microns long. The platinum catalyst 14 particle size is in the range of 2 to 3 nanometers. The PEM 17 thickness is in the range of 50 to 100 microns. The resulting-electrode assembly, as reported by Joo et al. [S. H. Joo, S. J. Choi, J. Kwak, Z. Liu, O. Terasaki, R. Ryoo, Nature, 412 (2001) 169] displayed an order of magnitude increase in the mass activity per gram of platinum (A/g of Pt) compared to a standard carbon black electrode. The increase in activity is reportedly due to a decrease in Pt cluster size, which exposes more Pt atoms to the gas-phase reactants. However, the experiments of Joo et al. show only an order of two increase in these surface Pt atoms, which means that a second factor is involved. This second factor is related to the nature of the porosity in the carbon black supports compared to the cluster of carbon nanotubes used in the experiments of Joo et al. The porous structure of carbon black is highly irregular and tortuous, and the Pt is dispersed throughout the pores. The reactant gases diffuse into these meandering pores and the products must diffuse out. The extent that the pore structure effects diffusion is defined as tortuosity, τ:

$$τ = \frac{actual distance molecule travels between two points}{shortest distance between two points}$$

Tortuosity is inversely proportional to the effective diffusion of a molecule, and can have a dramatic effect on the overall fuel cell efficiency if molecular transport to and from the reaction sites is a limiting factor. In other words, since most of the gas does not diffuse to the center of the carbon black particle, the Pt in the center is not efficiently utilized, so the overall output per gram of Pt decreases. Since the primary difference between carbon black and the nanotube clusters is the tortuosity of the pores, the lower tortuosity of the nanotube clusters contributes to the unexplained five-fold increase in activity. A 10-fold increase in Pt efficiency leads to a 10-fold decrease in the mass of Pt required, i.e. $65/kW is decreased to $6.50/kW, and if the same Pt density can be maintained there would be additional benefits with respect to the specific power since fewer cells would be required.

PEMFCs are attractive because they can generate more specific power (power normalized to the mass of fuel cell, e.g. W/kg) and power density (power normalized to the cross-sectional area of the electrodes, e.g. W/cm²) than any other current fuel cell. The electrical power is generated through controlled chemical reactions in a stack of fuel cells 36 containing the key components illustrated in FIG. 3. Bipolar plates 30, catalyst containing electrodes 32, and proton exchange membranes (PEM) 34. The bipolar plates 30 function both as the electronic connection between the fuel cells and the supplier (diffuser) of the reactant gases, typically hydrogen and oxygen (methanol and oxygen are also viable reactants for some small-scale applications).

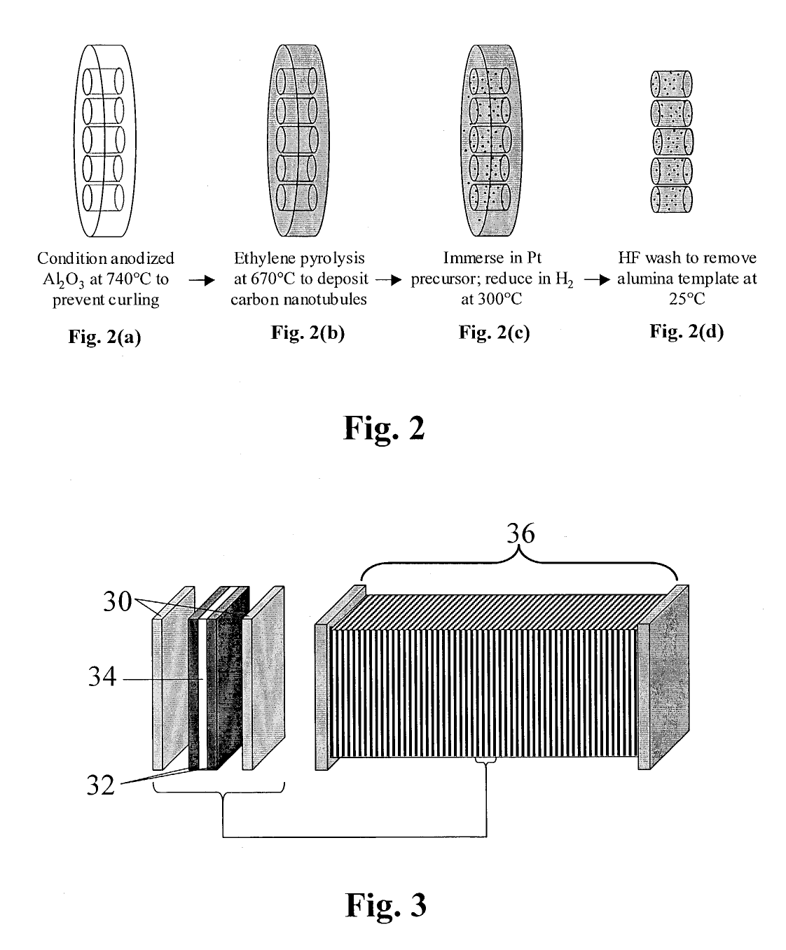

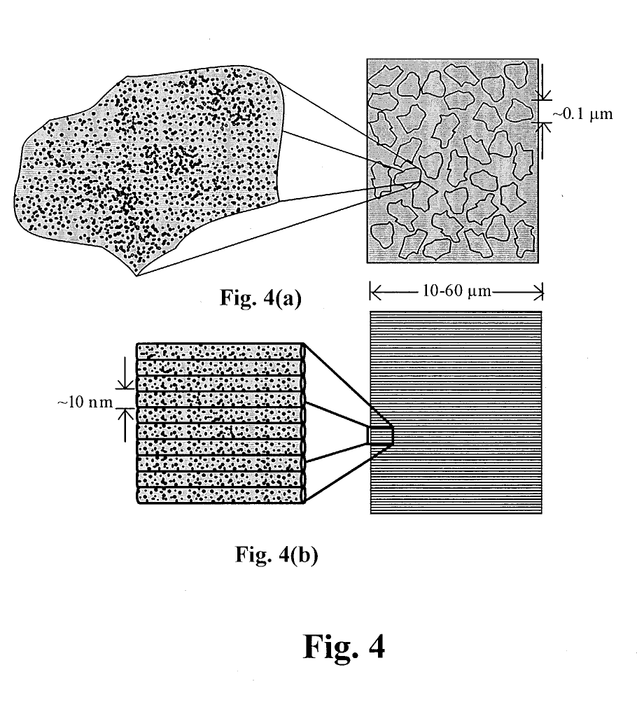

This invention comprises an alternative support system for this Pt-rich active layer, i.e. the layer where chemical reactions occur. The new technology is based on a recently reported method of aligned carbon nanotubule deposition in the pore structure of anodized alumina (often referred to as the template method) as depicted in FIG. 2. This technique allows the synthesis of an active layer with axially aligned carbon nanotubules as the Pt support, as depicted in FIG. 2b, and the result is electrodes comprised of a continuous array of these nanotubule layers shown in FIG. 4b. These axially aligned nanotubules lead to a tortuosity of unity for the entire active layer of the electrodes, which dramatically increases the overall mass activity of the assembly. This method also allows flexibility in controlling the nanotubule diameter (by selection of the alumina pore size), wall thickness (varying deposition time), and location of the Pt particles, either solely on the interior walls, or on all surfaces. This flexibility allows fine-tuning of the support's pore structure to achieve optimal diffusion, such that the effectiveness of each Pt reactive site would increase. Another embodiment is to decrease the template pore size to levels where molecular sieving is activated on the anode. If the penalty of diffusion is not great, it may be possible to block CO while allowing the smaller H₂ molecule to proceed through the electrode.

It is important to make a distinction between the nanotubules proposed here and the “classical” nanotube, i.e. a continuous seamless rolled graphite sheet. The carbon in this method is deposited uniformly on the walls of the template, and the resulting material is carbonaceous, tubular and nano-sized, but not a seamless graphitic sheet. The standard nanotubes are typically “grown” on nano-sized metal catalysts and result in graphite tubes with the same dimensions as the metal catalyst; however, significant amount of amorphous carbon is also formed, and it must be removed. This difficult separation process is mostly responsible for the current high cost of mass-producing nanotubes, especially aligned nanotube membranes. The method of this invention avoids this separation process since the carbon deposited on the walls of the alumina template is homogeneous. Aligned nanotubule arrays can be cost-effectively achieved using this invention and they offer an improvement over the prior art support structure due to their increased conductivity. Also, the nanotubule array of this invention increases the conductivity of the assembly as compared to the current membrane electrode assemblies and thus decreases the overpotential associated with proton diffusion.

Current membrane electrode assemblies (MEA), as shown in FIG. 4(a), use Pt clusters (2-3 nanometers) dispersed on carbon black supports that have a diameter of about 0.1 micron. Carbon black is particularly effective due to its high porosity and very high surface area (˜250 m²/g), which in turn enables high power densities since the surface area of the Pt support is proportional to the amount of catalyst in the cross sectional area of the electrode. These Pt-coated particles are then held together with a binder to constitute the 10-60 micron thick active layer of the anode and cathode. The instant invention is shown in FIG. 4(b). Significant improvement in electrocatalytic activity is experienced when Pt is deposited in an array of carbon nanotubules approximately 10 nm in diameter.

### Methods

A method for producing continuous axially aligned carbon nanotubules that are used as a Pt support in the electrode of a proton exchange membrane fuel cell (PEMFC) is taught here. Nanotubules are deposited in the uniform pores of an anodized gamma-phase (γ) Al₂O₃ membrane by chemical vapor deposition (CVD) or pyrolysis of ethylene. Pt is then dispersed on the interior of the nanotubules which form the continuous axially aligned active layer once the y-Al₂O₃ membrane is removed with an HF wash. The ID of the nanotubules in the array is tunable by varying deposition time. An essential element of the invention is that the axially aligned nanotubules in the anode and cathode are fabricated to form a free-standing layer that are continuous and straight such that the pathway for the reactants and products of the electrode reactions is highly efficient. The assembly transports reaction gases along the aligned axes of the anode and cathode layers in an essentially one-dimensional diffusion pathway for contact with the catalyst thereby improving the mass activity of the assembly. These nanotubule arrays constitute the active layer of the membrane assembly.

The synthesis of these axially aligned nanotubule arrays primarily follows the approach developed by C. R. Martin, Chem. Mater., 8 (1996) 1739. Commercially available anodized alumina disk membranes are available that are 60 μm thick, 5 cm in diameter, and with uniform pores of 20, 100, and 200 nm. Other membrane dimensions are possible following the aluminum oxidation procedure detailed by T. Kyotani, L.-F. Tsain, A. Tomita, Chem. Mater., 8 (1996) 2109. If unconditioned these membranes are susceptible to curling at high temperatures, but following a heat treatment at 740° C., as shown in FIG. 2(a), they subsequently remain flat at temperatures up to 700° C. Nanotubule deposition is now possible by pyrolyzing ethylene at 670° C. as depicted in FIG. 2(b). Platinum is deposited on the interior of the carbon-coated pores using a H₂PtCl₆ solution and subsequently dispersed by a H₂ reduction step at 300° C. as shown in FIG. 2(c). The alumina template is then removed in an HF solution to leave a freestanding layer of aligned carbon nanotubule supported Pt as represented in FIG. 2(d). The aligned tubes are further bound together using a 5% Nafion® solution (DuPont), and now represent the active layer of the electrodes. Electrochemical testing can commence at this point on the individual anode and cathode reactions, or can be combined with the Nafion® PEM membrane using a hot press at 195° C. and pressure of 70-90 atmospheres.

The active layers of this invention are partially impregnated with Nafion to ensure excellent proton mobility from the anode, through the PEM to the cathode. Prior art teaches the synthesis of an individual anode or cathode, but this invention teaches the combination of the anode and cathode with the polymer exchange membrane to form a complete PEM assembly having improved mass activity enabled by the one-dimensional diffusion pathway. Additionally, the electrodes resulting from the clusters developed by the prior art are not aligned as shown in FIG. 1, and therefore, resemble the morphology of the current technology rather than the assembly disclosed herein.

Two additional embodiments are related to the location of the Pt nanoclusters. In the preferred embodiment, the Pt is deposited only on the interior of the nanotubules. Due to potential mass flow limitations inside the nanotubules, the second embodiment has Pt dispersed on the outside of the tubes as well as the inside of the tubes. This is accomplished by depositing the Pt after the alumina removal step in FIG. 2(d). If mass transport is shown to be a significant barrier, a third embodiment continues the pyrolysis or CVD step of FIG. 2(b) until nanofibers are formed in the pores of the Al₂O₃ template thereby producing carbon nanorods. Platinum dispersion is performed on the outside surface of the nanorods after removing the template.

A method for making the preferred embodiment of the integrated electrode with platinum deposited on the interior of the carbon nanotubule pores comprises the steps of:

1. Condition anodized alumina template with 20 nm pores between plates of quartz at 740° C. in N₂.

2. Deposit carbon on conditioned alumina template by pyrolysis of ethylene at 670° C. Deposition time determines the pore size.

3. Deposit Pt on the interior of the pores using H₂PtCl₆ followed by reduction in H₂.

4. Remove the template by HF induced alumina decomposition.

5. Thoroughly rinse the freestanding carbon nanotubule membrane in water.

6. The aligned tubes are bound together using a 5% Nafion® solution (DuPont). This form is used in both the anode and cathode of the fully integrated electrode.

7. The carbon membranes are then pressed together with a 50-100 μm thick layer of Nafion between them. A hot press is used for this step at 195° C. and 1250 psi.

A method for making a second embodiment is used when depositing platinum on all surfaces of the carbon nanotubule membrane:

1. Condition anodized alumina template with 20 nm pores between plates of quartz at 740° C. in N₂.

2. Deposit carbon on conditioned alumina template by pyrolysis of ethylene at 670° C. Deposition time determines the pore size.

3. Remove the template by HF induced alumina decomposition.

4. Thoroughly rinse the freestanding carbon nanotubule membrane in water.

5. Deposit Pt using H₂PtCl₆ followed by reduction in H₂.

6. The aligned tubes are bound together using a 5% Nafion® solution (DuPont). This form is used in both the anode and cathode of the fully integrated electrode.

7. The carbon membranes are then pressed together with a 50-100 μm thick layer of Nafion between them. A hot press is used for this step at 195° C. and 1250 psi.

Another method for making a third embodiment is similar for depositing platinum on all surfaces of a membrane of carbon nano-rods:

1. Condition anodized alumina template with 20 nm pores between plates of quartz at 740° C. in N₂.

2. Deposit carbon on conditioned alumina template by pyrolysis of ethylene at 670° C. until the pores are filled (time to be determined).

3. Remove the template by HF induced alumina decomposition.

4. Thoroughly rinse the freestanding carbon nano-rod membrane in water.

5. Deposit Pt using H₂PtCl₆ followed by reduction in H₂.

6. The aligned rods are bound together using a 5% Nafion® solution (DuPont). This form is used in both the anode and cathode of the fully integrated electrode.

7. The carbon membranes are then pressed together with a 50-100 μm thick layer of Nafion between them. A hot press is used for this step at 195° C. and 1250 psi.

A fuel cell with this active layer would be useful as a power source for any application a PEMFC is capable of supporting, e.g. mobile vehicles, stationary generators, portable electronics, etc.

The following patents and publications further explain the art of membrane assemblies and are herein incorporated by reference in their entirety:

1. M. S. Wilson, U.S. Pat. No. 5,211,984; issued May 18, 1993.

2. P. Costamagna, S. Srinivasan, J. Power Sources, 102 (2001) 242.

3. P. Costamagna, S. Srinivasan, J. Power Sources, 102 (2001) 253.

4. E. J. Carlson, J. Thijssen, S. Sriramulu, G. Stevens, S. Lasher, Ref 49739, SFAA No. DE-SCO2-98EE50526, Topic 1-Subtopic 1C, August 2001.

5. S. Gottesfeld, J. Pafford, J. Electochem. Soc., 135 (1988) 2651.

6. T. J. Schmidt, H. A. Gasteiger, R. J. Behm, J. Electrochem. Soc., 146 (1999) 1296.

7. M. S. Wilson, T. E. Springer, T. A. Zawondski,. Gottesfeld, in: Procedings of the 28th Intersociety Energy Conversion Engineering Conference, 1 (1993 Atlanta, Ga.) 1203.

8. J. Divisek, H.-F. Oeijen, V. Peinecke, V. M. Schmidt, U. Stimming, Electrochim. Acta, 43 (1998) 3811.

9. S. H. Joo, S. J. Choi, J. Kwak, Z. Liu, O. Terasaki, R. Ryoo, Nature, 412 (2001) 169.

10. H. S. Fogler, Elements of Chemical Reaction Engineering, 2nd Edition, PTR Prentice Hall, Englewood Cliffs, N. J., 1992, 608.

11. C. R. Martin, Chem. Mater., 8 (1996) 1739.

12. T. Kyotani, L.-F. Tsain, A. Tomita, Chem. Mater., 8 (1996) 2109.

13. S. A. Miller, V. Y. Young, C. R. Martin, J. Am. Chem. Soc., 123 (2001) 12335.

14. C. Boyer, S. Gamburzev, O. A. Velev, S. Srinivasan, A. J. Appleby, Electrochimica Acta, 43, 24 (1998) 3703.

15. G. Che, B. B. Lakshmi, C. R. Martin, E. R. Fisher, Langmuir, 15 (1999) 750.

I claim:

1. An integrated membrane electrode assembly comprising;
at least one proton exchange membrane having a cathode surface and an anode surface,
at least one axially aligned carbon nanotubule anode layer disposed on said anode surface,
at least one axially aligned carbon nanotubule cathode layer disposed on said cathode surface, and
a catalyst disposed along the annulus of the carbon nanotubules of said anode layer and said cathode layer,
wherein said assembly transports reaction gases along the aligned axes of said anode and cathode layers in an essentially one-dimensional diffusion pathway for contact with said catalyst thereby improving the mass activity of said assembly.

2. The assembly of claim 1 wherein said proton exchange membrane is Nafion.

3. The assembly of claim 1 wherein the carbon nanotubules in said anode layer have an inside diameter in the range of approximately 5 to 15 nanometers, preferably about 10 nanometers.

4. The assembly of claim 1 wherein the carbon nanotubules in said cathode layer have an inside diameter in the range of approximately 5 to 15 nanometers, preferably about 10 nanometers.

5. The assembly of claim 1 wherein the carbon nanotubules in said anode cluster have a tortuosity in the range of approximately 0.9 to 1.

6. The assembly of claim 1 wherein the carbon nanotubules in said cathode cluster have a tortuosity in the range of approximately 0.9 to 1.

7. The assembly of claim 1 wherein the carbon nanotubules in said anode layer have an outside diameter in the range of approximately 18 to 22 nanometers, preferably about 20 nanometers.

8. The assembly of claim 1 wherein the carbon nanotubules in said cathode layer have an outside diameter in the range of approximately 18 to 22 nanometers, preferably about 20 nanometers.

9. The assembly of claim 1 wherein the carbon nanotubules in said anode layer have a length in the range of approximately 10 to 60 microns.

10. The assembly of claim 1 wherein the carbon nanotubules in said cathode layer have a length in the range of approximately 10 to 60 microns.

11. The assembly of claim 1 wherein said catalyst in platinum.

12. The assembly of claim 1 wherein said catalyst is disposed only on the inside diameter of the nanotubules in said anode layer and said cathode layer.

13. The assembly of claim 1 wherein said catalyst is disposed on the inside diameter and outside diameter of the nanotubules in said anode layer and said cathode layer.

14. An integrated membrane electrode assembly comprising;
at least one proton exchange membrane having a cathode surface and an anode surface,
at least one axially aligned carbon nanorod anode layer disposed on said anode surface,
at least one axially aligned carbon nanorod cathode layer disposed on said cathode surface, and
a catalyst disposed on the surface of said carbon nanorods in said anode layer and said cathode layer,
wherein said assembly transports reaction gases along the aligned axes of said anode and cathode layers in an essentially one-dimensional diffusion pathway for contact with said catalyst thereby improving the mass activity of said assembly.

15. The assembly of claim 14 wherein said catalyst in platinum.

16. A method for making an integrated membrane electrode assembly comprising the sequential steps of:
a. Conditioning at least two anodized alumina templates with 20 nm pores between plates of quartz at 740° C. in N₂,
b. Depositing carbon on the conditioned alumina templates by pyrolysis of ethylene at 670° C.,
c. Depositing a catalyst on the interior of the template pores using H₂PtCl₆ followed by reduction in H₂,
d. Removing the templates by HF induced alumina decomposition thereby forming freestanding axially aligned carbon nanotubule membranes,
e. Rinsing the freestanding membranes in water,
f. Binding together selected membranes using a 5% Nafion® solution to form an anode layer and a cathode layer, and
g. Hot pressing, at approximately 195° C. and 1250 psi, the anode layer and cathode layer to opposite surfaces of a PEM to form a membrane assembly having a 50-100 μm thick layer of PEM between the anode and cathode layers wherein a portion of the anode layer and the cathode layer are infused with the proton exchange membrane.

17. The method of claim 16 wherein said proton exchange membrane is Nafion®.

18. The method of claim 16 wherein the carbon nanotubules in said anode layer have an inside diameter in the range of approximately 5 to 15 nanometers, preferably about 10 nanometers.

19. The method of claim 16 wherein the carbon nanotubules in said cathode layer have an inside diameter in the range of approximately 5 to 15 nanometers, preferably about 10 nanometers.

20. The method of claim 16 wherein the carbon nanotubules in said anode layer have a tortuosity in the range of approximately 0.9 to 1.

21. The method of claim 16 wherein the carbon nanotubules in said cathode layer have a tortuosity in the range of approximately 0.9 to 1.

22. The method of claim 16 wherein the carbon nanotubules in said anode layer have an outside diameter in the range of approximately 18 to 22 nanometers, preferably about 20 nanometers.

23. The method of claim 16 wherein the carbon nanotubules in said cathode layer have an outside diameter in the range of approximately 18-22 nanometers, preferably about 20 nanometers.

24. The method of claim 16 wherein the carbon nanotubules in said anode layer have a length in the range of approximately 10 to 60 microns.

25. The method of claim 16 wherein the carbon nanotubules in said cathode layer have a length in the range of approximately 10 to 60 microns.

26. The method of claim 16 wherein said catalyst in platinum.

27. A method for making an integrated membrane electrode assembly comprising the sequential steps of:
a. Conditioning at least two anodized alumina templates with 20 nm pores between plates of quartz at 740° C. in N₂,
b. Depositing carbon on the conditioned alumina templates by pyrolysis of ethylene at 670° C.,
c. Removing the templates by HF induced alumina decomposition thereby forming freestanding axially aligned carbon nanotubule membranes,
d. Rinsing the freestanding membranes in water,
e. Depositing a catalyst on the inside diameter and outside diameter of the nanotubules using H₂PtCl₆ followed by reduction in H₂,
f. Binding together selected membranes using a 5% Nafion® solution to form an anode layer and a cathode layer, and
g. Hot pressing, at approximately 195° C. and 1250 psi, the anode layer and cathode layer to opposite surfaces of a PEM to form a membrane assembly having a 50-100 μm thick layer of PEM between the anode and cathode layers wherein a portion of the anode layer and the cathode layer are infused with the proton exchange membrane.

28. The method of claim 27 wherein said proton exchange membrane is Nafion®.

29. The method of claim 27 wherein the carbon nanotubules in said anode layer have an inside diameter in the range of approximately 5 to 15 nanometers, preferably about 10 nanometers.

30. The method of claim 27 wherein the carbon nanotubules in said cathode layer have an inside diameter in the range of approximately 5 to 15 nanometers, preferably about 10 nanometers.

31. The method of claim 27 wherein the carbon nanotubules in said anode layer have a tortuosity in the range of approximately 0.9 to 1.

32. The method of claim 27 wherein the carbon nanotubules in said cathode layer have a tortuosity in the range of approximately 0.9 to 1.

33. The method of claim 27 wherein the carbon nanotubules in said anode layer have an outside diameter in the range of approximately 18 to 22 nanometers, preferably about 20 nanometers.

34. The method of claim 27 wherein the carbon nanotubules in said cathode layer have an outside diameter in the range of approximately 18-22 nanometers, preferably about 20 nanometers.

35. The method of claim 27 wherein the carbon nanotubules in said anode layer have a length in the range of approximately 10 to 60 microns.

36. The method of claim 27 wherein the carbon nanotubules in said cathode layer have a length in the range of approximately 10 to 60 microns.

37. The method of claim 27 wherein said catalyst in platinum.

38. A method for making an integrated membrane electrode assembly comprising the sequential steps of:
a. Conditioning at least two anodized alumina templates with 20 nm pores between plates of quartz at 740° C. in N₂,
b. Depositing carbon on the conditioned alumina templates by pyrolysis of ethylene at 670° C. until all pores are filled with carbon,
c. Removing the templates by HF induced alumina decomposition thereby forming freestanding axially aligned carbon nanorod membranes,
d. Rinsing the freestanding membranes in water,
e. Depositing a catalyst on the nanorods using H₂PtCl₆ followed by reduction in H₂,
f. Binding together selected membranes using a 5% Nafion® solution to form an anode layer and a cathode layer, and
g. Hot pressing, at approximately 195° C. and 1250 psi, the anode layer and cathode layer to opposite surfaces of a PEM to form a membrane assembly having having a 50-100 μm thick layer of proton exchange membrane between the anode and cathode layers wherein a portion of the anode layer and the cathode layer are infused with the proton exchange membrane.

39. The method of claim 38 wherein said proton exchange membrane is Nafion®.

40. The method of claim 38 wherein said catalyst in platinum.
